(19) United States
(12) Patent Application Publication
(10) Pub. No.: US 2021/0326718 A1
(43) Pub. Date: Oct. 21, 2021

(54) MACHINE LEARNING TECHNIQUES TO SHAPE DOWNSTREAM CONTENT TRAFFIC THROUGH HASHTAG SUGGESTION DURING CONTENT CREATION

(71) Applicant: Microsoft Technology Licensing, LLC, Redmond, WA (US)

(72) Inventors: Brian S. Olson, Oakland, CA (US); Hitesh Kumar, San Francisco, CA (US); Ankan Saha, San Francisco, CA (US)

(21) Appl. No.: 16/850,357

(22) Filed: Apr. 16, 2020

(51) Int. Cl. G06N 5/04; G06N 20/00; G06F 16/9536

(52) U.S. Cl. CPC G06N 5/04; G06F 16/9536; G06N 20/00

(57) ABSTRACT

Machine learning techniques for shaping downstream content traffic through hashtag suggestion during content creation are provided. In one technique, content item interaction data is stored that indicates, for each of multiple content items that is associated with one or more hashtags, whether a viewer interacted with the content item. Based on the content item interaction data, multiple training instances are generated, each corresponding to a different hashtag. One or more machine learning techniques are used to train a machine-learned downstream interaction model based on the training instances. Based on a particular content item, multiple candidate hashtags are identified. The machine-learned downstream interaction model is used to generate a score for each of the candidate hashtags. A subset of the candidate hashtags is selected based on the scores generated. The subset of the candidate hashtags are caused to be presented on a computing device.

### TECHNICAL FIELD

The present disclosure relates to machine learning and, more particularly, to using machine learning techniques to shape content traffic that is downstream from content creation.

### BACKGROUND

Modern content distribution systems leverage hashtags in their online ecosystem. A hashtag is a word or phrase preceded by a hash sign (#) and is used to identify content items on a specific topic. For example, a user might submit a search on a specific hashtag or phrase and, in response, a content distribution system identifies content items including a hashtag that matches the search input and causes those content items to be presented to the user. As another example, a user might subscribe to a specific hashtag and a content distribution system that stores, or has access to, many content items will notify the user of any content item that is associated with that specific hashtag.

However, many users are either unaware of the utility of hashtags or are unsure of what hashtags to include in their respective posts. As a result, many posts of content items to a content distribution system lack appropriate hashtags, preventing those potentially relevant content items from being presented to potentially interested users. One approach for addressing this lack of hashtag use is for the content distribution system to suggest one or more hashtags to a poster or uploader of content and allowing the poster to select one or more of the hashtag suggestions. In this way, a content item may be associated with a hashtag without the poster having to manually specify a hashtag.

One approach to determine which hashtags to suggest to a poster is to compare existing hashtags with text of a content item that the poster has uploaded or is composing. This increases the likelihood that any suggested hashtags are relevant to the subject matter of the content item. However, such an approach is primitive and does not take into account how potential viewers of a content item might interact with the content item depending on the associated hashtags.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for suggesting hashtags to content creators, in an embodiment;

FIG. 2 is a flow diagram that depicts an example process for identifying hashtag suggestions, for a content item, from among a set of candidate hashtags, in an embodiment;

FIG. 3 is a flow diagram that depicts an example process for training and leveraging a machine-learned downstream interaction model, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for using machine learning to determine, based on a history of downstream interactions with content items associated with hashtags, which hashtags to suggest to content creators. In one technique, one or more machine-learned models are trained based on one or more sets of training data. Each training instance in one set of training data corresponds to a hashtag and includes one or more feature values of the hashtag and a label representing a number or amount of downstream interactions (e.g., shares, comments, likes) with content items associated with the hashtag. The resulting machine-learned model is used to score each candidate hashtag. The candidate hashtags with the highest scores may be selected to be suggested hashtags for a content creator.

Embodiments improve computer-related technology. Specifically, embodiments improve computerized hashtag suggestion technology so that suggested hashtags are more relevant and, if selected, shape downstream interactions with content items associated with the hashtags. Prior approaches relied on simple rules to determine what hashtag suggestions might be relevant for a content creator to select and failed to take into account downstream interactions by other users with respect to content items that are associated with hashtags. Some embodiments involve using machine learning techniques to train one or more models that are used to select candidate hashtags as suggestions to content creators.

A goal for assigning hashtags to a content item is increasing engagement. It may be the case that assigning some specific hashtags results in a significant increase in the engagement with a content item. However, such hashtags might not have the highest probability of being chosen or selected by the content creator (or author) of the content item in the hashtag selection phase and, therefore, might not be shown to the content creator if only the selection probability is considered. Embodiments estimate downstream utilities of hashtags and incorporate those utilities in an objective of a hashtag suggestion optimization framework.

### Definitions

A hashtag is a word or phrase preceded by a hash sign (#) and is used on social media websites and applications (e.g., Twitter) to identify content items on a specific topic. A hashtag is an example of metadata for a content item. Some content items may be associated with one or more hashtags while other content items might not be associated with any hashtags. In data storage, a content item may be associated with one or more hashtags. For example, a table may comprise at least two columns: one column for content item identifiers and another column for a list of hashtags or hashtag identifiers. A separate table may store actual text of the hashtags. Later, a hashtag search engine may have access to the hashtag storage in order to lookup content items that are associated with a particular hashtag or set of hashtags. For example, given a text phrase that a user inputs into a text field of a search interface, a search engine searches a hashtag table for hashtags that match (exactly or partially) the inputted text phrase. For each row or record in the hashtag table that matches the inputted text phrase, the corresponding content item identifiers are retrieved. The search engine then uses the content item identifiers to look up, in a content item table, information about the content items associated with the content item identifiers, such as brief text descriptions of the content items or links to web pages about the individual content items.

A content item comprises content of one or more types, such as text, image, audio, graphics, virtual reality, video, or any combination thereof. Example content items include (e.g., news or sports) articles, (e.g., blog) posts, (e.g., movie or restaurant) reviews, text strings, surveys, and links. A content item may include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

A “content creator” is a user that creates or otherwise uploads a content item to a content distribution system, such as LinkedIn. (The content creator may be a registered user of the content distribution system.) Thus, a content creator of a content item may not be the originator (or original author) of the content item; rather, the content creator may be one that uploads the particular content to the content distribution system or includes a link to the particular content, which may already be hosted on the content distribution system. Thus, some who “shares” a content item (e.g., by clicking on a share button adjacent to the content item) may be considered a content creator, at least with respect to users in a connection network of the content creator.

### System Overview

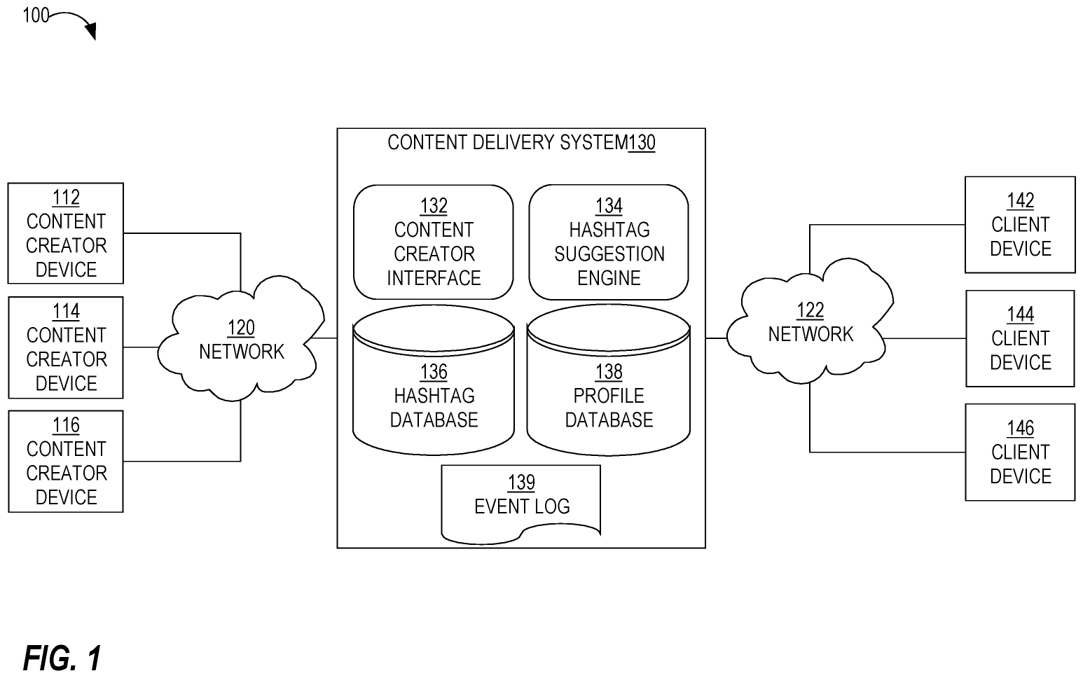

FIG. 1 is a block diagram that depicts a system 100 for suggesting hashtags to content creators, in an embodiment. System 100 includes content creator devices 112-116, a network 120, a content delivery system 130, and client devices 142-146. Although three content creator devices are depicted, system 100 may include more or less content creator devices. Similarly, system 100 may include more client devices.

Content creator devices 112-116 interact with content delivery system 130 over network 120 to enable content items to be presented to end-users operating client devices 142-146 over network 122, which may be the same or different than network 120. Thus, content creator devices 112-116 provide (e.g., upload, compose) content items to content delivery system 130, which in turn selects content items to provide to client devices 142-146 for presentation to users thereof. However, at the time that a content creator registers with content delivery system 130, neither party may know which end-users or client devices will receive content items from the content creator.

Each of networks 120 and 122 may be implemented on any medium or mechanism that provides for the exchange of data between clients 110-114 and content delivery system 130. Examples of networks 120 and 122 include, without limitation, a network such as a Local Area Network (LAN), Wide Area Network (WAN), Ethernet or the Internet, or one or more terrestrial, satellite or wireless links.

Although depicted in a single element, content delivery system 130 may comprise multiple computing elements and devices, connected in a local network or distributed regionally or globally across many networks, such as the Internet. Thus, content delivery system 130 may comprise multiple computing elements, including file servers and database systems. For example, content delivery system 130 includes: (1) a content creator interface 132 that allows content creator devices 112-116 to upload or create their respective content items; (2) a hashtag suggestion engine 134 that conducts hashtag suggestion selection events in response to receipts of the content items; (3) a hashtag database 136 that contains information about existing hashtags; and (4) a profile database 138 that contains information about content creators, potential viewers of content items, or both.

Content delivery system 130 (or an associated system) may provide additional content (i.e., other than content items from content creators) to client devices 142-146 in response to requests initiated by users of client devices 142-146 or in response to other events. The additional content may be about any topic, such as news, sports, finance, and traveling. A content request from a client device may be in the form of a HTTP request that includes a Uniform Resource Locator (URL) and may be issued from a web browser or a software application that is configured to communicate with content delivery system 130 (or an associated system). A content request may be a request that is immediately preceded by user input (e.g., selecting a hyperlink on web page) or may be initiated as part of a subscription, such as through a Rich Site Summary (RSS) feed. In response to a request for content from a client device, content delivery system 130 (or an associated system) provides the requested content (e.g., a web page) to the client device.

A request that triggers a hashtag suggestion selection event (described in more detail herein) is referred to herein as a “hashtag suggestion request.” Hashtag suggestion engine 134 receives hashtag suggestion requests. Hashtag suggestion requests may originate from content creator interface 132 when, for example, a content creator uploads a file containing a content item, enters text into a text field, includes a link to a content item that is to be uploaded, or selects a “hashtag suggestion” button that is presented to the content creator during a content creation process.

In response to receiving a hashtag suggestion request, hashtag suggestion engine 134 initiates a content item selection event that involves selecting one or more content items (from among multiple content items) to present to the client device that initiated the content request.

Examples of devices 112-116 and 142-146 include desktop computers, laptop computers, tablet computers, wearable devices, video game consoles, and smartphones.

### Hashtag Suggestion Selection Events

A hashtag suggestion selection event is an event when multiple candidate hashtags are considered and a subset (e.g., multiple) selected for presentation on a computing device of a content creator. One or more events may trigger a hashtag suggestion selection event. For example, the receipt of a content item by content delivery system 130 for sharing with other users associated with (e.g., connected to) the content creator may triggers a hashtag suggestion selection event. For example, in response to a content creator uploading a content item to content delivery system 130, hashtag suggestion engine 134 analyzes one or more attributes of the content item and/or one or more attributes of the content creator to identify zero or more candidate hashtags. One or more filtering criteria may be applied to reduce the total number of candidate hashtags that are considered, such as any hashtags that do not match a portion of text within a content item are removed from consideration.

A final set of candidate hashtags is ranked based on one or more criteria, such as actual selection rate. Different candidate hashtags may be associated with different selection rates. Generally, candidate hashtags associated with relatively high selection rates may be selected for presentation to candidate hashtags associated with relatively low selection rates. Other factors may limit the effect of selection rates, such as one or more measures of relevance of the candidate hashtag to the content item and/or to the content creator.

In an embodiment, hashtag suggestion engine 134 conducts one or more hashtag suggestion selection events. Thus, hashtag suggestion engine 134 has access to all data (e.g., using hashtag database 136 and profile database 138) associated with making a decision of which candidate hashtag(s) to select, such as an identity of the content creator (to which hashtag suggestions will be presented), an indication of whether a candidate hashtag was previously presented to the content creator, an actual selection rate of each candidate hashtag, and/or a predicted selection rate of each candidate hashtag.

### Event Logging

Content delivery system 130 may log one or more types of events, with respect to hashtags and hashtag suggestions, across content creator devices 112-116 and client devices 142-146 (and other client devices not depicted). For example, content delivery system 130 determines whether a hashtag suggestion that is associated with a content item is presented at (e.g., displayed by) a content creator device along with the content item. Such an “event” is referred to as a “hashtag suggestion impression.” In some cases, a hashtag suggestion is sent to a content creator device but not presented. Further, content delivery system 130 determines whether a user of the content creator device interacted with (e.g., selected) the hashtag suggestion.

As another example, content delivery system 130 determines whether a content item (that is associated with one or more hashtags that were selected by a content creator) is presented at (e.g., displayed by) a client device along with the content item. Such an “event” is referred to as a “content item impression.” Also, content delivery system 130 determines whether a user of the client device interacted with the content item that includes the one or more hashtags.

Examples of user interaction of a hashtag suggestion include a selection, such as (a) a content creator touching a portion, of a touchscreen display, that includes a hashtag suggestion or (b) the content creator hovering a cursor of a cursor control device (e.g., a mouse) over the hashtag suggestion. Examples of user interaction of a content item that includes a hashtag include a viewer (a) selecting the content item, (b) viewing the content item for a certain period of time (e.g., over two seconds), (c) commenting on, liking, or sharing the content item. Content delivery system 130 stores such data as user interaction data, including an impression data set and/or an interaction data set. Thus, content delivery system 130 may include an event log 139. Logging such events allows content delivery system 130 to track how well different hashtag suggestions perform and how different content items that include selected hashtags perform.

### Associating Hashtags with a Content Item

A content creator may manually specify a hashtag that s/he wants to associate with a content item that the content creator provides (e.g., creates, uploads, or shares). Such a hashtag allows other users of content delivery system 130 to view the content item if the other users “follow” the hashtag (e.g., by previously selecting a “follow” button adjacent to the hashtag on another webpage), are searching on the hashtag, or have otherwise indicated interest in the hashtag (e.g., by viewing other posts, articles, content that are associated with the hashtag).

The manual specification of a hashtag may occur prior to the content item being created, uploaded, or shared. Alternatively, the manual specification of a hashtag may occur after the creation, uploading, or sharing event has occurred. For example, a content creator uploads a particular content item to content delivery system 130 and the particular content item becomes a candidate content item to present to other users of the content delivery system 130. Later, the content creator is presented with a list of content items that the content creator has provided to the content delivery system 130. The content creator selects the particular content item and is presented with an option to add a hashtag. The content creator then manually specifies a hashtag that will thereafter be associated with the particular content item.

### Hashtag Suggestion

Another way to associate a hashtag with a content item is for content delivery system 130 to automatically suggest hashtags to a content creator, who then manually accepts zero or more of the suggested hashtags. Content delivery system 130 may implement one or more rules to identify candidate hashtags to suggest.

For example, one rule may be to suggest only hashtags that have been selected or specified by users in the past. Another rule may be to suggest hashtags that exactly (or nearly) match text within the corresponding content item. Another rule may be to suggest only hashtags that the corresponding content creator has selected previously. Another rule may be to suggest only hashtags that have a certain number of followers. Another rule may be to suggest only hashtags that have been associated with a certain number of content items. Such rules may be individually applied or applied in a group. For example, any hashtag that satisfies either (a) the matching hashtag rule or (b) (i) the previous selection rule and (ii) either the follower rule or the content item rule, is a candidate to be suggested to the content creator.

### Hashtag Suggestion Data Items

One type of impression data item is a hashtag suggestion impression data item. Content delivery system 130 receives hashtag suggestion impression data items, each of which is associated with a different instance of a hashtag suggestion impression and a particular hashtag suggestion. A hashtag suggestion impression data item may indicate a particular hashtag suggestion, a hashtag suggestion selection event identifier that uniquely identifies the hashtag suggestion selection event that occurred in order to identify the particular hashtag suggestion as a suggestion, a date of the impression, a time of the impression, a particular content creator device that presented the particular hashtag suggestion (e.g., through a device or browser identifier), and/or a user identifier of a user (or content creator) that operates the particular content creator device. Thus, different hashtag suggestion impression data items may be associated with different hashtag suggestions. One or more of these individual data items may be encrypted to protect privacy of the end-user.

One type of interaction data item is a hashtag suggestion interaction data item, which may indicate a particular hashtag suggestion, a hashtag suggestion selection event identifier that uniquely identifies the hashtag suggestion selection event that occurred in order to identify the particular hashtag suggestion as a suggestion, a date of the user interaction, a time of the user interaction, a particular content creator device that presented the hashtag suggestion, and/or a user identifier of a user (or content creator) that operates the particular content creator device. If hashtag suggestion impression data items are generated and processed properly, a hashtag suggestion interaction data item should be associated with a hashtag suggestion impression data item that corresponds to the hashtag suggestion interaction data item. Such an association may be determined by matching hashtag suggestion selection event identifiers in the respective data items.

From hashtag suggestion interaction data items and impression data items associated with a hashtag suggestion, content delivery system 130 may calculate an observed (or actual) user selection rate for the hashtag suggestion. Also, from hashtag suggestion interaction data items and impression data items associated with a hashtag creator, content delivery system 130 may calculate a selection rate for the hashtag creator. Similarly, from interaction data items and impression data items associated with a class or segment of users (or users that satisfy certain criteria, such as users that have a particular job title), content delivery system 130 may calculate a user interaction rate for the class or segment. In fact, a user interaction rate may be calculated along a combination of one or more different content creator and/or hashtag suggestion attributes or dimensions, such as geography, job title, skills, certain keywords, etc.

### Content Item Data Items

Another type of impression data item is a content item impression data item. Content delivery system 130 receives content item impression data items, each of which is associated with a different instance of a content item impression and a particular content item. A content item impression data item may indicate a particular content item (e.g., using a unique content item identifier), a set of hashtags (e.g., a set of unique hashtag identifiers) that was associated with the particular content item, a date of the content item impression, a time of the impression, a particular client device that presented the particular content item (e.g., through a device or browser identifier), and/or a user identifier of a user that operated the particular client device. Thus, different content item impression data items may be associated with different and/or the same hashtags. One or more of these individual data items may be encrypted to protect privacy of the end-user.

Another type of interaction data item is a content item interaction data item, which may indicate a content item, a set of hashtags that were associated with the content item, a date of the user interaction, a time of the user interaction, a type of the user interaction (e.g., a comment, share, click, like, or other reaction), a particular client device that presented the hashtag suggestion, and/or a user identifier of a user (or content creator) that operates the particular client device. If content item impression data items are generated and processed properly, a content item interaction data item should be associated with a content item impression data item that corresponds to the content item interaction data item. Such an association may be made by a common content item selection event identifier in both data items, which identifier uniquely identifies a content item selection event that resulted in identifying the corresponding content item as a candidate for presentation on a client device.

From content item interaction data items and impression data items associated with a content item, content delivery system 130 may calculate an observed (or actual) user interaction rate (e.g., user selection rate) for content items that are associated with a particular hashtag. Also, from content item interaction data items and impression data items associated with a user/viewer of content items, content delivery system 130 may calculate a selection rate for the user/viewer pertaining to content items that have a particular hashtag. Similarly, from content item interaction data items and impression data items associated with a class or segment of users (or users that satisfy certain criteria, such as users that have a particular job title), content delivery system 130 may calculate, for the class or segment, a user interaction rate of content items that are associated with a particular hashtag. In fact, a user interaction rate for content items that are associated with a hashtag may be calculated along a combination of one or more different user/viewer and/or hashtag attributes or dimensions, such as geography, job title, skills, certain keywords, etc.

### Optimizing Hashtag Suggestion for Selection

In an embodiment, hashtag suggestions are optimized for selection. That is, hashtags that are identified as candidates for suggestion to one or more content creators are identified based on a hashtag selection history of past content creators. For example, an analysis of previous hashtag suggestions that were selected by content creators is made to determine which hashtags to suggest for subsequent content items that content delivery system 130 receives from content creators. Thus, a hashtag suggestion that has a relatively low content creator selection rate might not be considered as a candidate for a subsequent content creator. Conversely, a hashtag suggestion that has a relatively high content creator selection rate is selected for suggestion to a subsequent content creator based on that high selection rate.

Optimizing hashtag suggestions for content creator selection may be performed in one or more ways. For example, a rule-based approach may be used where a selection rate is calculated for each hashtag. If a candidate hashtag (that otherwise qualifies as a candidate for a hashtag selection event because, for example, the hashtag matches a string in the corresponding content item) has a content creator selection rate over a particular threshold, then the candidate hashtag is identified as a hashtag suggestion that is presented to the corresponding content creator. Conversely, if a candidate hashtag has a content creator selection rate below the particular threshold, then the candidate hashtag is not identified as a hashtag suggestion.

Alternatively, a machine learning-based approach may be used to identify hashtag suggestions for presentation.

### Machine Learning

Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating a machine-learned model. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

A machine-learned model may output different types of data or values, depending on the input features and the training data. For example, training data may comprise, for each hashtag, multiple feature values, each corresponding to a different feature of the hashtag or the content creator that selected the hashtag. In order to generate the training data, information about each user and/or each hashtag is analyzed to compute the different feature values. In this example, the dependent variable of each training instance may be a number of user interactions on content items that are associated with the corresponding hashtag. Additionally or alternatively, the dependent variable of each training instance may indicate a log of such a number.

### A Machine Learned Model that is Optimized for Selection

Regarding a machine-learned model for optimizing content creator selections of hashtag suggestions, example features of such a model include one or more attributes of the content creator and one or more attributes of a candidate hashtag. Values of those attributes are input to the model, which generates a score that may represent a probability or likelihood that the content creator will select the candidate hashtag. The score may be used to filter out the candidate hashtag (e.g., because the score is below a particular threshold) and/or may be used to rank the candidate hashtag relative to other candidate hashtags, given their respective scores.

Examples of attributes of a candidate hashtag include actual selection rate, an embedding for the hashtag that has been learned or generated by a word embedding model, such as Word2Vec, number of times the hashtag was used in last N days, and number of followers of the hashtag. Values for such attributes may be retrieved by hashtag suggestion engine 134 from a record or file in hashtag database 136.

Examples of attributes of a content creator include job industry, employer company, country, job title, job function, seniority, years of experience, academic degrees earned, schools attended, skills. Values for such attributes may be found in a profile of the content creator, which values may be retrieved by hashtag suggestion engine 134 from profile database 138.

Example attributes of content that a content creator has provided include an embedding for the content and a semantic similarity of the content with a candidate hashtag (using the embedding of the content and an embedding for the candidate hashtag).

Training data for the machine-learned model for optimizing selections comprises multiple training instances. Hashtag suggestion engine 134 (or another component of content delivery system 130) generates the training data. Each training instance corresponds to a hashtag suggestion and may be generated based on hashtag suggestion interaction and impression data items. For example, hashtag suggestion engine 134 computes a content creator selection rate of each hashtag suggestion of multiple hashtag suggestions and inserts the selection rate in a training instance for that hashtag suggestion. The hashtag suggestion interaction and impression data items may be limited to a certain period of time, such as data items that were generated or received in the last four weeks or the last thirty days.

Additionally, hashtag suggestion engine 134 (or another component of content delivery system 130) identifies, for each training instance, a content creator identifier that is associated with an impression data item. Such an identifier may be a user identifier or a device identifier. The content creator identifier is used to look up attributes of the corresponding content creator in profile database 138.

Also, hashtag suggestion engine 134 (or another component of content delivery system 130) generates a label for each training instance. The label indicates whether the hashtag suggestion that corresponds to the training instance was selected by the corresponding content creator. Such a selection may be indicated in a hashtag suggestion interaction data item that relates, or corresponds, to a hashtag suggestion impression data item.

Once the training data is generated, a machine-learned model may be trained, based on at least a portion of the training data, using one or more machine learning techniques. Initial weights or coefficients of features of the machine-learned model may be randomly selected from an open set (virtually any number), randomly selected from a closed set of options (e.g., between −5 and 5), and/or manually specified based on a model developer's best guess. Training the model may involve determining whether the weights or coefficients of the models features have not changed significantly. If not, then model training may cease. Once the machine-learned model is trained, the machine-learned model may be validated, for example, based on a different portion of the training data than the portion that was used to train the model. Based on validation, a threshold output value is selected that maximizes precision, recall, or both. The selection may be automatic based on one or more rules.

### Neural Network

In an embodiment, an artificial neural network is trained and used to identify hashtag suggestions. The neural network may be separate from the machine-learned model described above. Alternatively, the neural network may be the “deep” part of a deep and wide machine-learned model, where the wide part includes the features described previously, such as features of candidate hashtags and features of the content creator. In such a deep and wide model, the edge weights of the neural network and the weights/coefficients of the wide part are learned together. For example, a single training instance may cause the weights of the wide part and the weights of the deep part to be modified in the same iteration.

In an embodiment, the training data that is generated to train the neural network is based on hashtag interaction data from a certain time period, such as the last year. The content items that are considered may be limited to content items that have a minimum number of characters (e.g., two hundred). Also, the hashtags that are considered may be limited to hashtags that were used (or appeared in content items) a minimum number of times (e.g., five hundred). Each content item may be analyzed to remove stop words (e.g., “a,” “and,” “but,” “how,” “or,” and “what”). Also, the number of words that are considered in each content item (e.g., post) maybe limited to a certain number, such as the first one hundred words. Of all the words that are remaining after such preprocessing, only the top N words in the data set, in terms of frequency, may be considered. For example, the top 30K words in the data set are considered for word embeddings.

Each training instance corresponds to a content item that has been through pre-processing (e.g., to remove stop words and infrequent words). For each word that remains after pre-processing, a word embedding is determined. Such a determination may be made by obtaining a word embedding from a pre-trained word embedding model, such as Word2Vec and GloVe, which contains vector representations for hundreds of thousands of words. The word embeddings of the remaining words of a content item may be combined (e.g., max pooling or mean pooling) to generate a combined word embedding for the content item and, consequently, for the corresponding training instance. The architecture of the neural network may vary from one implementation to another. In one example architecture, the neural network comprises an embedding layer, followed by a flatten layer, followed by two dense layers with 64 nodes with ReLU activations, followed by a dense layer with M nodes and a sigmoid activation, where M is the number of candidate hashtags. The label of each training instance are the hashtags considered and a different number of labels can be assigned to each training instance, since the same post may have multiple hashtags. The neural network may then be trained used the generated training instances.

In an embodiment, a candidate hashtag is only presented to a content creator if one of the following conditions is satisfied: the candidate hashtag matches (at least partially) text within the content item, the candidate hashtag was selected by the content creator previously (e.g., with respect to a different content item), or the candidate hashtag has a score from the neural network that is above a particular threshold. In a related embodiment, a candidate hashtag that satisfies one or more of these conditions is then ranked based on profile features of the content creator, such as a machine-learned model that is trained based on those profile features (and, optionally, one or more hashtag features).

### Example Process for Identifying Hashtag Suggestions

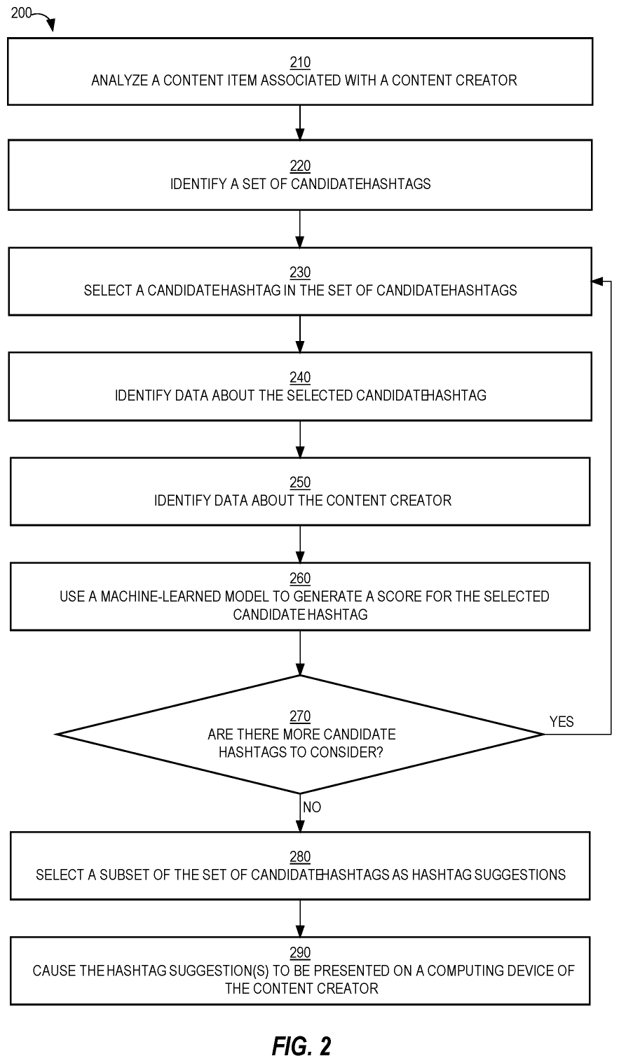

FIG. 2 is a flow diagram that depicts an example process 200 for identifying hashtag suggestions, for a content item, from among a set of candidate hashtags, in an embodiment. Process 200 may be implemented by hashtag suggestion engine 134 and/or associated components of content delivery system 130.

Process 200 may be performed online, i.e., in response to a content creator providing a content item to content delivery system 130 and before the content item is made available to a connection network of the content creator. Thus, candidate hashtags are scored online. Additionally or alternatively, process 200 may be performed offline, i.e., after a content item is made available to a connection network of a content creator that provided the content item to content delivery system 130.

At block 210, a content item is analyzed. Block 210 may involve receiving the content item from a content creator device or retrieving the content item from another source over a computer network. “Receiving” the content item may involve receiving a file containing the content item from the content creator device. Alternatively, “receiving” may involve receiving text input from the content creator device, which input comprises text characters that the content creator selects on a (physical or electronic) keyboard.

At block 220, a set of candidate hashtags is identified. The set of candidate hashtags may come from one or more sources. For example, text portions in the content item are to a database of known hashtags. If there is a match with a known hashtag, then that hashtag becomes a candidate hashtag. As another example, hashtags that the content creator has selected before are identified as candidate hashtags. As yet another example, hashtags that the content creator has explicitly followed (or otherwise shown interest in) are identified as candidate hashtags.

At block 230, a candidate hashtag in the set of candidate hashtags is selected. Block 230 may involve selecting any one of the set of candidate hashtags randomly or in a particular order.

At block 240, data about the candidate hashtag selected in block 230 is identified. The data may be retrieved from hashtag database 136. The data may comprise multiple data items, each corresponding to a different feature (or attribute) of the candidate hashtag, which feature is reflected in the machine-learned model. Block 240 may involve formatting and organizing the data into a format and arrangement that is expected by the machine-learned model.

At block 250, data about the content creator is identified. The data may comprise multiple data items, each corresponding to a different feature (or attribute) of the content creator, which feature is reflected in the machine-learned model. The first time block 250 is performed in the current performance of process 200 may involve identifying an identifier for the content creator. Such an identifier may be included in an upload request that included in the content item. Alternatively, such an identifier may be in session information that is associated with a current session of the content creator. The content creator identifier is then used to retrieve the data about the content creator, for example, from profile database 138. Like block 240, block 250 may involve formatting and organizing the data (about the content creator) into a format and arrangement that is expected by the machine-learned model.

At block 260, the machine-learned model is invoked to generate a score for the candidate hashtag selected in block 230. Input to the machine-learned model includes the data about candidate hashtag (identified in block 240) and the data about the content creator (identified in block 250).

At block 270, it is determined whether there are any more candidate hashtags that have not yet been processed. If so, then process 200 returns to block 230, where another candidate hashtag is selected. Otherwise, process 200 proceeds to block 280.

At block 280, a subset of the set of candidate hashtags is selected as hashtag suggestions. For example, the top N candidate hashtags in terms of score are selected. As another example, any candidate hashtag with a score above a particular threshold is selected.

At block 290, the hashtag suggestion(s) is/are caused to be presented on a content creator device. Block 290 may involve sending the hashtag suggestions over a computer network (e.g., the Internet) to the content creator device with instructions that, when processed by the content creator device, causes the hashtag suggestions to be presented in certain locations within web content. If multiple hashtag suggestions are sent, then the order in which the hashtag suggestions are presented may be based on their respective scores.

In some cases, a content creator provides multiple inputs when providing a content item to content delivery system 130. For example, a content creator types in text into a text field of a user interface. The text becomes at least a part of the content item that the content creator provides. In an embodiment, process 200 repeats for each word or phrase that is entered by a content creator. For example, process 200 is performed for the first ten words that a content creator enters into a text field. Then, process 200 is performed for the first ten words and the next three words that the content creator enters into the text field. In this way, the set of candidate hashtags that is presented to the content creator may change while the content creator enters text that becomes part of a content item.

In an embodiment where a neural network has been trained, process 200 may involve pre-processing the content item to identify words from which word embeddings are retrieved and combined to generate a combined word embedding. The combined word embedding is input to the neural network, which outputs M values, where M is the number of candidate hashtags upon which the neural network is based. (Another way to use a neural network to generate candidate hashtags is to use a sequence-to-sequence model given text from the provided content.) Thus, neither block 230 nor block 270 is performed, at least where a neural network is the only component that generates scores for selecting candidate hashtags.

If an output value in the M values is greater than a certain threshold, then the candidate hashtag that corresponds to that output value may be automatically selected (or at least ranked) based on that output value. Different candidate hashtags may be associated with different thresholds. Thus, an output value for one candidate hashtag may need to be higher than the output value for another candidate hashtag in order to be selected or ranked.

### Optimizing Hashtag Suggestion for Downstream Iterations

In an embodiment, the selection of candidate hashtags as suggestions is optimized for one or more downstream interactions. The amount of downstream interaction of a hashtag may be measured in a number of ways, such as a number of user selections of content items with the hashtag, a user interaction rate of content items with the hashtag, a number of comments on content items with the hashtag, a number of shares of content items with the hashtag, and/or a number of reactions on content items with the hashtag. An example of a reaction is a “Like.” In an online social network, one user “liking” a content item makes it more likely that connections of the user will be notified of the content item or otherwise be presented with the content item. Thus, “downstream interaction” may be in one of these example interactions or any combination thereof.

In an embodiment, one or more of these measures of downstream interaction is used to directly rank candidate hashtags. For example, the higher the user selection rate of content items with a particular hashtag, the more likely that the particular hashtag will be identified as a hashtag suggestion for a particular content creator.

### A Machine Learned Model that is Optimized for Downstream Interaction

In an embodiment, a machine-learned model is trained that outputs a score that represents a prediction of a downstream utility of a hashtag, such as the number of downstream interactions that users will have with a content item that includes the hashtag. Example features of the machine-learned, downstream utility model pertain to feed interactions, hashtag feed visits, connection network, hashtag followers, usage score, and a unique actor score.

A “feed interaction” pertaining to a hashtag is a user interaction with a content item that includes the hashtag, where the content item is in a feed of content items. Example user interactions of a content item include a click of the content item and viral actions associated with the content item, such as a comment on the content item, a share of the content item, and a “like” of the content item. The feed may be a scrollable (e.g., vertical) feed that allows a user to view many (e.g., a virtually unlimited number of) content items within a view, such as a web page or in a native client application executing on a mobile device. Thus, an example feature of the machine-learned, downstream utility model is a feed interaction rate pertaining to a hashtag. The feed interaction rate may be a ratio of (1) a number of feed interactions of pertaining to a hashtag to (2) a number of impressions of content items that include the hashtag. Both numbers may be limited to a certain period of time, such as the last two weeks.

A “hashtag feed visit” is a visit, by a user, of a profile page of (or dedicated to) a hashtag. For example, profile database 138 may contain profiles of different types of entities, such as users, organizations (e.g., companies), and hashtags. A profile page of a hashtag may include information about when the hashtag began, a number of followers of the hashtag, an identity of the user who started the hashtag, and a listing of content items that contain the hashtag, which listing may be ranked based on number of views or other interactions with the content items. A hashtag feed visit may originate in one or more ways. For example, a user might initiate a search on a hashtag page, which search produces a set of results, each of which links to a different hashtag profile page. As another example, a link to a hashtag profile page may appear on home page of a user, where the hashtag profile page is automatically recommended to the user based on one or more attributes of the user and/or one or more attributes of the corresponding hashtag. Example features, of the machine-learned model, pertaining to hashtag feed visits may be a number of hashtag feed visits in the last week, a number of hashtag feed visits in the last two weeks, and a number of hashtag feed visits in the last four weeks. The machine-learned model may include (or be based on) one or more of these features.

A “hashtag follower” is a user that provided input that indicates the user's intention to “follow” a particular hashtag. “Following” a hashtag results in activity related to the hashtag being more likely to presented to the corresponding user through one or more channels of delivery, such as notifications, messages, and feed updates. For example, if a user follows a hashtag, then the user may receive a notification whenever a content item that is associated with the hashtag is received by content delivery system 130 (or an affiliated system). As another example, if a user follows a hashtag, then the one or more content items that are associated with the hashtag are (or are more likely to be) included in the user's content item feed that is presented on the user's client device. In an embodiment, the number of followers of a hashtag is a feature in the machine-learned, downstream utility model.

A “usage score” of a hashtag is a measure of a relative popularity (in terms of being associated with content items) of the hashtag over a period of time (e.g., the last thirty days). The usage score of a hashtag may be calculated by determining a ratio of (1) the number of times the hashtag appears with content items (or the number of content items that include, or are associated with, the hashtag) to (2) the number of times the most popular (in terms of usage) hashtag appears with content items. In mathematical notation:

Sᵢ=Uᵢ/max_{1<=j<=|U|}Uⱼ

where Sᵢ is the usage score of hashtag i, U is the set of usage counts of all hashtags over a certain time period, and |U| is the total number of hashtags in that set.

A “unique actor score” of a hashtag is a measure of a relative popularity of the hashtag over a period of time (e.g., the last thirty days). The unique actor score of a hashtag may be calculated by determining a ratio of (1) the number of times the hashtag appears with content items that were interacted with to (2) the number of times the most popular hashtag (in terms of unique actors). In mathematical notation:

Aᵢ=Qᵢ/max_{1<=j<=|U|}Qⱼ

where Aᵢ is the unique actor score of hashtag i, Q is the set of unique actor counts of all hashtags over a time period, |Q| is the total number of hashtags in that set, and Qᵢ is the set of unique actor counts of hashtag i over that time period.

### Connection Network

“Connection network” refers to a connection network of a content creator. The connection network of a content creator is a set of connections (or “friends”) that the content creator established in an online connection (or “social”) network, such as LinkedIn. For each user that became a connection of the content creator, the content creator provided input, to the network platform, that indicates approval that the user become a connection of the content creator. Connections of a user are allowed to message the user and/or share content with the user, at least more easily than if those users were not connections of the user.

In an embodiment, one or more aspects of the connection network of a content creator are one or more features of the machine-learned downstream utility model. For example, an average content item interaction rate is calculated for the connection network of a content creator, which rate may be calculating by determining the individual content item interaction rate of each connection in the connection network. The individual content item interaction rate of each connection may be respect to all content items that the connection has viewed or with respect to only content items that the content creator has provided. The average content item interaction rate may be a feature in the model and may positively correlate with the number or amount of downstream interactions of one or more types. After training the model, the learned coefficient or weight for this feature may indicate that the higher the average content item interaction rate, the higher the amount of downstream interactions.

As another example, a connection network of a content creator is analyzed to determine a set of segments of the connection network and a relative size of each segment. For example, the connection network of a content creator may be analyzed to determine an industry of each connection (e.g., using profile database 138) and group all connections of the content creator based on industry. Different industries may be associated with different interaction rates and the size of each segment represented in the connection network of the content creator may be used to calculate an overall interaction rate, which may be used as a feature in the machine-learned model. Additionally or alternatively, a set of features of the machine-learned model may be the size of each segment represented in the connection network.

If one or more attributes of a connection network of a content creator are not part of the machine-learned downstream utility model, then all (or many) potential candidate hashtags may be scored by the machine-learned downstream utility model in an offline manner, i.e., not in response to a upload of a content item by a content creator. (Otherwise, generating a score for each possible hashtag-content creator pair would take a significant amount of time since there are so many such pairs and many or most of those pairs will never be utilized.) Thus, the machine-learned downstream utility model (once trained and validated) may generate a score for each hashtag in set of known hashtags and that score is stored (e.g., in non-volatile or volatile memory) in association with the hashtag.

### Weighted Training Data

It is possible that a content item is associated with (or is assigned) multiple hashtags. If a user interacts with the content item, then it may not be clear which hashtag is most responsible for the interaction, if at all. Thus, in one embodiment, all hashtags associated with a single content item that has been interacted with by one or more users are treated equally. For example, when calculating a number of user interactions with content items that are associated with a particular hashtag, if the particular hashtag was associated with a content item that was interacted with (e.g., selected by) a particular user, then that interaction is considered a single interaction and causes the total count for that particular hashtag to increase by one.

In an alternative embodiment, the training data of the machine-learned, downstream utility model is modified based on the number of hashtags per content item (e.g., post). Modifying training data may involve adding a weight to a training instance pertaining to a particular hashtag or adding a weight to a label of the training instance. (A weight of a training instance dictates the extent to which one or more (or all) coefficients of a model are modified in response to training the model based on the training instance.) For example, if a content item is associated with ten hashtags, then a user (viewer) interaction with the content item means that a total count for each hashtag will be increased by one tenth.

In the case where the label is a log of the number of downstream interactions, the label may be weighted as log(interactions)/number of hashtags. For example, a post P1 had two hashtags, H1 and H2, and received one hundred interactions. Thus, log(100)=10. Therefore, the resulting training data may have two samples corresponding to this post, where the label for each sample is 10/2=5:
a. P1 H1 5
b. P1 H2 5

In a related embodiment, the fact that a viewer is a follower of a hashtag is taken into account when calculating a weight for a label. For example, a viewer comments on a post that has ten hashtags and the viewer has followed four of those ten hashtags. The training instances corresponds to the four hashtags may have higher weights or weighted labels than the training instances that correspond to the other six hashtags.

### Combining Outputs from Multiple Machine-Learned Models

While a candidate hashtag may be ranked individually by either the machine-learned selection model described herein (pSelect) or the machine-learned downstream utility model described herein (dUtility), in an embodiment, each candidate hashtag in a set of candidate hashtags is ranked based on output from pSelect and dUtility. For example, for each candidate hashtag for a content item, a score from pSelect is combined with a score from dUtility to produce a combined score. The combined score of each candidate hashtag in the set is used to rank that set. The top N candidate hashtags in terms of combined score (or all candidate hashtags whose combined scores are above a certain threshold) are identified as hashtag suggestions and presented to the corresponding content creator.

An example formula to combine scores from the respective models is the following:

Score(c,h)=pSelect (c,h)(1+alpha*dUtility(h))

where Score(c, h) is the final score of recommending hashtag h to content creator c, pSelect(c, h) is the output of hashtag pSelect model, dUtility(h) is the output of the downstream utility model, and alpha is a weight that may be tuned manually or automatically. In a related embodiment, dUtility also takes into account one or more attributes of the connection network of content creator c.

### Additional Use of Machine-Learned, Downstream Utility Model

In an embodiment, scores generated by a dUtility model is used to rank candidate content items for a viewer. The candidate content items may be candidates for inserting into slots of an online feed of the viewer. For example, there may be twenty slots to fill and one thousand candidate content items. Many of the candidate content items are associated with one or more hashtags. Each candidate content item may already have a score generated for it based on the dUtility model. Such a score may be used to rank the candidate content items either directly or indirectly with one or more other scores from other models. Since the candidate content items are uploaded to content delivery system 130 and, thus, already have hashtags associated with them, the score from a pSelect model is unnecessary.

### Modifying the Process for Identifying Hashtag Suggestions

To account for multiple machine-learned models, each outputting a different score for the same candidate hashtag, process 200 may be modified to include (1) a block that involves invoking the other machine-learned model(s) (e.g., the dUtility model) and (2) a block that combines the scores output from all machine-learned models pertaining to the candidate hashtag to generate a combined score for the candidate hashtag.

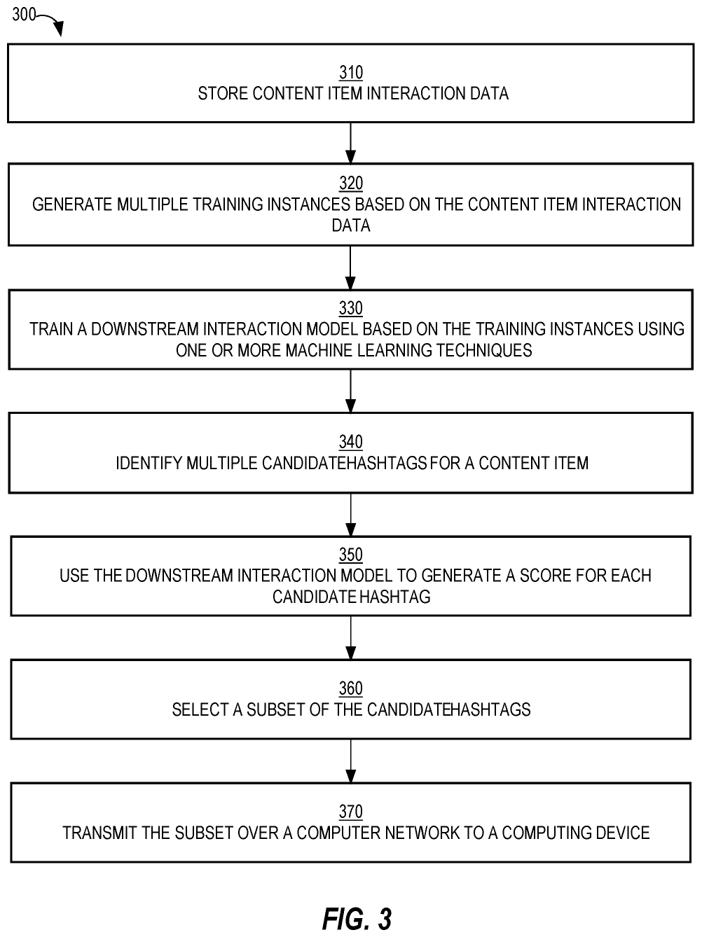

FIG. 3 is a flow diagram that depicts an example process 300 for training and leveraging a machine-learned downstream interaction model, in an embodiment. Process 300 may be performed by content delivery system 130 and/or one or more associated systems/components. Blocks 310-330 (which corresponds to training data generation and model training) may be performed in offline while blocks 340-370 (which corresponds to model scoring) may be performed in real-time. Blocks 310-330 may be performed at less regular intervals (e.g., every three weeks) than blocks 340-370 (e.g., continuously).

At block 310, content item interaction data is stored. The content item interaction data indicates, for each content item of multiple content items that is associated with one or more hashtags, whether a viewer interacted with said each content item. The data items in such data may be generated based on data retrieved from multiple client devices.

At block 320, multiple training instances are generated based on the content item interaction data. Each training instance corresponds to a different hashtag of multiple hashtags. The multiple hashtags may be limited to a particular set of hashtags, such as the top N most frequently used hashtags in the last M days. Thus, some content item interaction data items may be removed from consideration if they are not associated with a hashtag in the particular set.

Block 320 may involve computing, for each hashtag, feature values for each feature the hashtag (such as a number of followers of the hashtag) and a target or dependent variable value for the hashtag, such as a log of the number of interactions with the hashtag.

At block 330, the downstream interaction model is trained based on the training instances using one or more machine learning techniques.

At block 340, multiple candidate hashtags are identified for a content item. Block 340 may involve receiving the content item from a content creator, either directly from a client device of the content creator or indirectly through a different source where the content item is stored. Block 340 may be similar to block 220.

At block 350, the downstream interaction model is used to generate a score for each candidate hashtag. Block 350 may involve, for each candidate hashtag identified in block 340, identifying multiple feature values of the candidate hashtag and inputting the feature values into the downstream interaction model.

At block 360, a subset of the candidate hashtags is selected as hashtag suggestions. Block 360 may involve identifying the top N candidate hashtags in terms of score. The scores may be the scores generated in block 350 or at least based on the scores generated in block 350. For example, the score of a candidate hashtag may be a combination of the score generated by the downstream interaction model and a score generated by a machine-learned selection model (e.g., pSelect).

At block 370, the subset of the candidate hashtags is transmitted to a computing device, which presents the candidate hashtags in the subset as hashtag suggestions. Alternatively, the content item may be automatically associated with the hashtag suggestions, for example, if the combined score is above a certain threshold, such as one that is higher than another threshold that is used to determine whether to present the candidate hashtags as suggestions. The computing device may be a device operated by a content creator that provided the content item to content delivery system 130.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

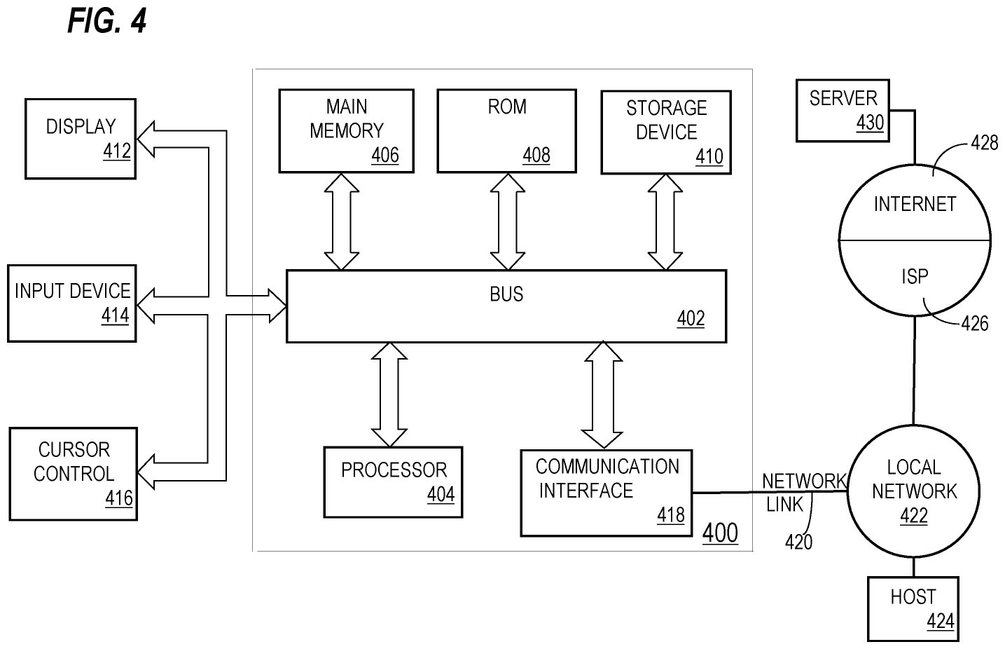

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing content item interaction data that indicates, for each content item of a plurality of content items that is associated with one or more hashtags, whether a viewer interacted with said each content item;
based on the content item interaction data, generating a plurality of training instances, each corresponding to a different hashtag of a plurality of hashtags;
using the one or more machine learning techniques to train a machine-learned downstream interaction model based on the plurality of training instances;
based on a particular content item, identifying a plurality of candidate hashtags;
using the machine-learned downstream interaction model to generate a score for each candidate hashtag in the plurality of candidate hashtags;
selecting a subset of the plurality of candidate hashtags based on the scores generated, using the machine-learned downstream interaction model, for the plurality of candidate hashtags;
causing the subset of the plurality of candidate hashtags to be presented on a computing device;
wherein the method is performed by one or more computing devices.

2. The method of claim 1, further comprising:
receiving, from the computing device, input that selects one or more candidate hashtags in the subset;
in response to receiving the input, storing the one or more candidate hashtags in association with the particular content item.

3. The method of claim 1, wherein the viewer interacted with said each content item if the viewer commented on said each content item, reacted to said each content item, or selected said each content item.

4. The method of claim 1, wherein identifying the plurality of candidate hashtags comprises one or more of:
identifying one or more first hashtags that a content creator, that is providing the content item, has selected for one or more other content items that the content creator has provided previously;
identifying one or more second hashtags that match, at least in part, one or more tokens in the content item; or
identifying one or more third hashtags that are identified based on scores output by a neural network that accepts, as input, one or more word embeddings that are generated based on text within the content item.

5. The method of claim 1, further comprising:
storing a machine-learned selection model that was trained based on a second plurality of training instances, each corresponding to a different hashtag of the plurality of hashtags and indicating whether the different hashtag was selected by a content creator to be associated with a content item;
using the machine-learned selection model to generate a second score for each candidate hashtag in the plurality of candidate hashtags;
wherein selecting the subset is further based on the second scores generated, based on the machine-learned selection model, for the plurality of candidate hashtags.

6. The method of claim 1, wherein a feature of the machine-learned downstream interaction model is based on a number of feed interactions of content items that include a particular hashtag.

7. The method of claim 1, wherein a feature of the machine-learned downstream interaction model is based on a connection network of a content creator that might be presented with a candidate hashtag.

8. The method of claim 1, wherein the machine-learned downstream interaction model outputs a prediction that is based on an estimate of a number of interactions of content items that include a particular hashtag.

9. The method of claim 1, wherein a feature of the machine-learned downstream interaction model is based on a number of user visits of a page that is dedicated to a particular hashtag.

10. The method of claim 1, wherein a feature of the machine-learned downstream interaction model is based on a number of followers of a particular hashtag.

11. One or more storage media storing instructions which, when executed by one or more processors, cause:
storing content item interaction data that indicates, for each content item of a plurality of content items that is associated with one or more hashtags, whether a viewer interacted with said each content item;
based on the content item interaction data, generating a plurality of training instances, each corresponding to a different hashtag of a plurality of hashtags;
using the one or more machine learning techniques to train a machine-learned downstream interaction model based on the plurality of training instances;
based on a particular content item, identifying a plurality of candidate hashtags;
using the machine-learned downstream interaction model to generate a score for each candidate hashtag in the plurality of candidate hashtags;
selecting a subset of the plurality of candidate hashtags based on the scores generated, using the machine-learned downstream interaction model, for the plurality of candidate hashtags;
causing the subset of the plurality of candidate hashtags to be presented on a computing device.

12. The one or more storage media of claim 11, wherein the instructions, when executed by the one or more processors, further cause:
receiving, from the computing device, input that selects one or more candidate hashtags in the subset;
in response to receiving the input, storing the one or more candidate hashtags in association with the particular content item.

13. The one or more storage media of claim 11, wherein the viewer interacted with said each content item if the viewer commented on said each content item, reacted to said each content item, or selected said each content item.

14. The one or more storage media of claim 11, wherein identifying the plurality of candidate hashtags comprises one or more of:
identifying one or more first hashtags that a content creator, that is providing the content item, has selected for one or more other content items that the content creator has provided previously;
identifying one or more second hashtags that match, at least in part, one or more tokens in the content item; or
identifying one or more third hashtags that are identified based on scores output by a neural network that accepts, as input, one or more word embeddings that are generated based on text within the content item.

15. The one or more storage media of claim 11, wherein the instructions, when executed by the one or more processors, further cause:
storing a machine-learned selection model that was trained based on a second plurality of training instances, each corresponding to a different hashtag of the plurality of hashtags and indicating whether the different hashtag was selected by a content creator to be associated with a content item;
using the machine-learned selection model to generate a second score for each candidate hashtag in the plurality of candidate hashtags;
wherein selecting the subset is further based on the second scores generated, based on the machine-learned selection model, for the plurality of candidate hashtags.

16. The one or more storage media of claim 11, wherein a feature of the machine-learned downstream interaction model is based on a number of feed interactions of content items that include a particular hashtag.

17. The one or more storage media of claim 11, wherein a feature of the machine-learned downstream interaction model is based on a connection network of a content creator that might be presented with a candidate hashtag.

18. The one or more storage media of claim 11, wherein the machine-learned downstream interaction model outputs a prediction that is based on an estimate of a number of interactions of content items that include a particular hashtag.

19. The one or more storage media of claim 11, wherein a feature of the machine-learned downstream interaction model is based on a number of user visits of a page that is dedicated to a particular hashtag.

20. The one or more storage media of claim 11, wherein a feature of the machine-learned downstream interaction model is based on a number of followers of a particular hashtag.
